(19) United States
(12) Patent Application Publication
(10) Pub. No.: US 2015/0322695 A1
(43) Pub. Date: Nov. 12, 2015

(54) SAFE WITH NITINOL WIRE LOCKING MECHANISM

(71) Applicant: Leslie Ho Leung Chow, Shilouzhen Panyu District (CN)

(72) Inventor: Leslie Ho Leung Chow, Shilouzhen Panyu District (CN)

(21) Appl. No.: 14/273,769

(22) Filed: May 9, 2014

(51) Int. Cl. E05B 47/00; E05B 51/00; E05B 65/00; E05B 49/00; E05G 1/02; E05G 1/10

(52) U.S. Cl. CPC E05B 47/0009; E05G 1/02; E05G 1/10; E05B 65/0075; E05B 65/0082; E05B 49/00; E05B 51/005; E05G 2700/00

(57) ABSTRACT

A safe. A safe lid is connected to a safe box via a hinge attachment. The safe is locked shut by utilization of a latch assembly. A Nitinol wire is connected to a latch assembly opening device. The latch assembly opening device is connected to the latch assembly. A user can open the safe by inputting the correct pass code into a keypad. An electrical signal is then transferred to the Nitinol wire causing the Nitinol wire to shorten. The shortening of the Nitinol wire causes the latch assembly opening device to open the latch assembly. In a preferred embodiment a key lock is also configured to control the latch assembly opening device and the key lock may be used as another method to open the safe.

The present invention relates to safes, and in particular, to locking devices for safes.

### BACKGROUND OF THE INVENTION

Safe boxes (also known as “safes”) are well known in the prior art. They are used primarily to protect documents, currency, jewelry, and other valuables from fire and theft. Stand alone safes are very common in homes and businesses throughout the world. A fire-resistant safe (also known as a “fire safe”) is a type of safe that is designed to protect its contents from high temperatures or actual fire. There are various types of locking mechanisms currently being utilized for safes that incorporate known technologies.

### Nitinol Wire

Nitinol Wire (also known as ‘Muscle Wire’ or ‘Memory Wire’) is a thin strand of a special shape memory alloy composed primarily of Nickel (Ni) and Titanium (Ti). Nitinol Wire will shorten in length after receiving an electrical signal, or heated by other means. Nitinol wire returns to its original length the electrical signal is removed and/or cooled.

What is needed is a better safe that allows operation through a user controlled keypad as well as a backup operation via a hand held key.

### SUMMARY OF THE INVENTION

The present invention provides a safe. A safe lid is connected to a safe box via a hinge attachment. The safe is locked shut by utilization of a latch assembly. A Nitinol wire is connected to a latch assembly opening device. The latch assembly opening device is connected to the latch assembly. A user can open the safe by inputting the correct pass code into a keypad. An electrical signal is then transferred to the Nitinol wire causing the Nitinol wire to shorten. The shortening of the Nitinol wire causes the latch assembly opening device to open the latch assembly. In a preferred embodiment a key lock is also configured to control the latch assembly opening device and the key lock may be used as another method to open the safe.

### BRIEF DESCRIPTION OF THE DRAWINGS

FIG. 1 shows a perspective view of a preferred safe.

FIG. 2A shows a top view of a preferred safe.

FIG. 2B shows a front view of a preferred safe.

FIGS. 3A-4C show the internal features of a preferred safe.

FIGS. 5A-5E show illustrate the locking mechanism of a preferred safe.

FIGS. 6A-6C show the function of the key lock.

FIG. 7 shows a preferred fire safe.

### DETAILED DESCRIPTION OF THE PREFERRED EMBODIMENTS

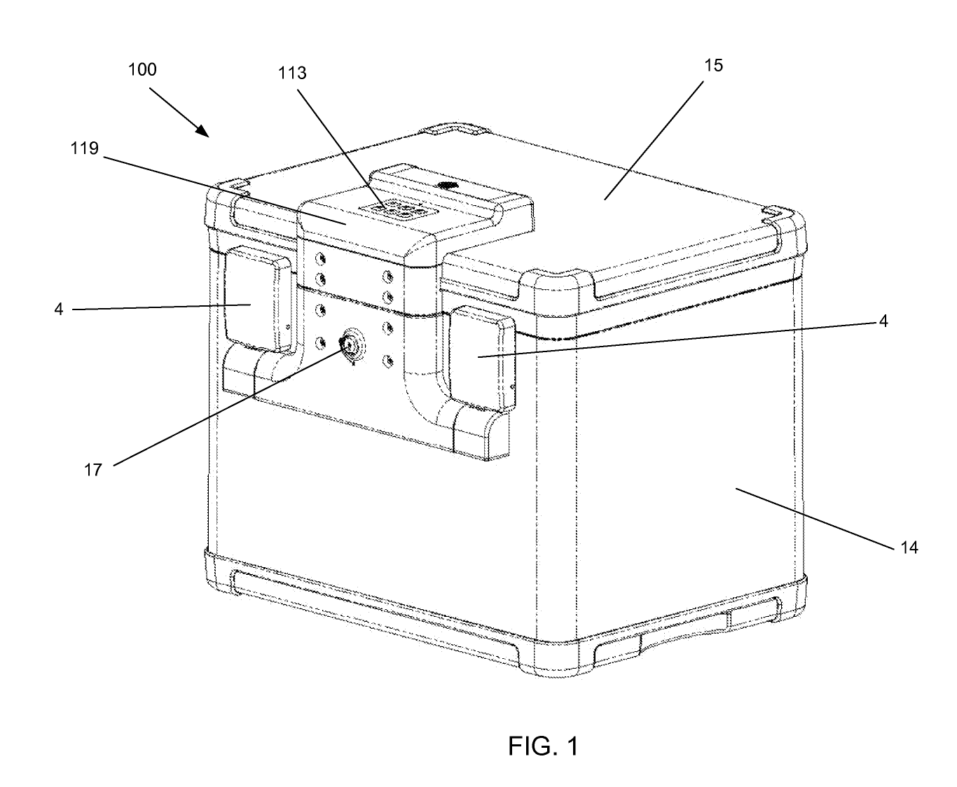

FIG. 1 shows digital fire safe 100 having lid 15 and box 14. Lid 15 is connected to box 14 via hinges 135. When digital fire safe 100 is closed, the safe is locked by the latch assembly 4. The safe can only be opened after latch assembly 4 is released from the lid 15. When emergency key lock 17 is under the lock position, latch assembly 4 can be released automatically by utilizing keypad 113. As an alternative or in an emergency, safe 100 can be opened by utilizing key lock 17. Hence, key lock 17 can then be used as a second or backup method for opening the safe.

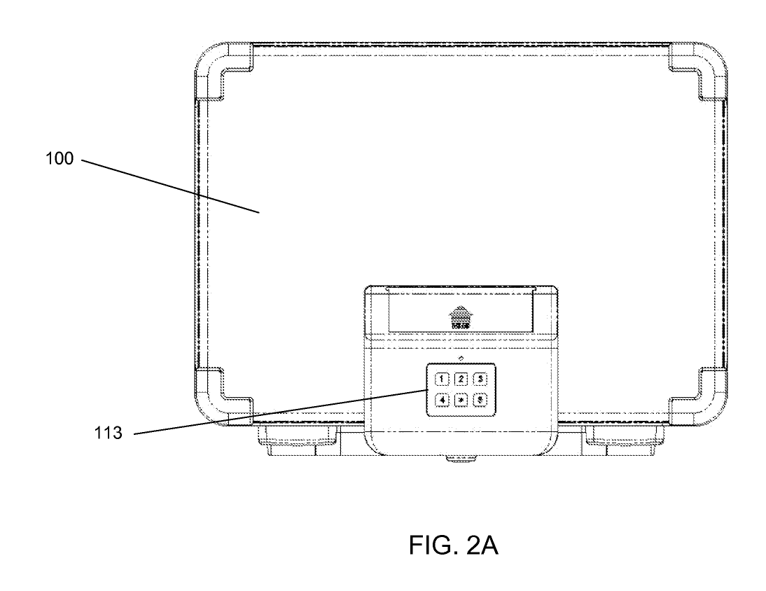

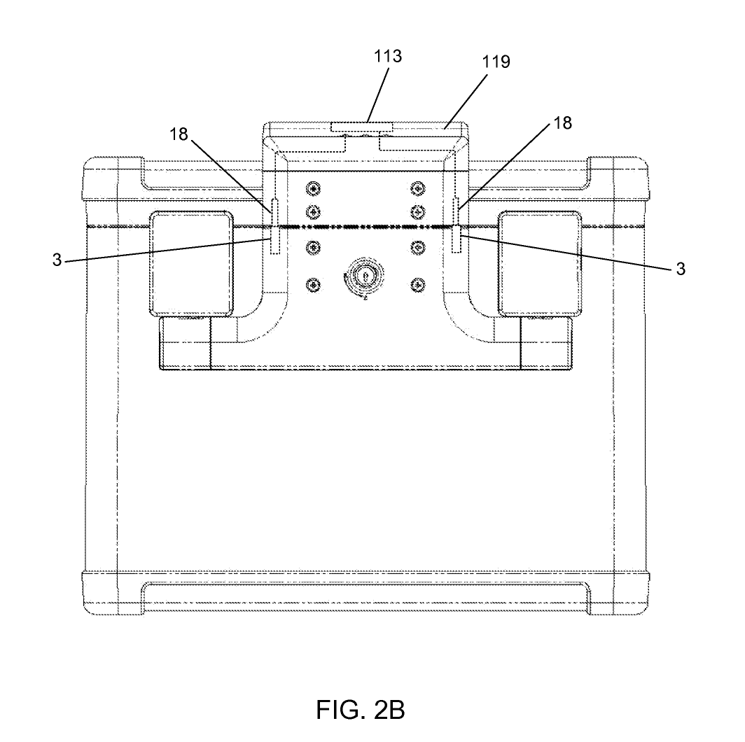

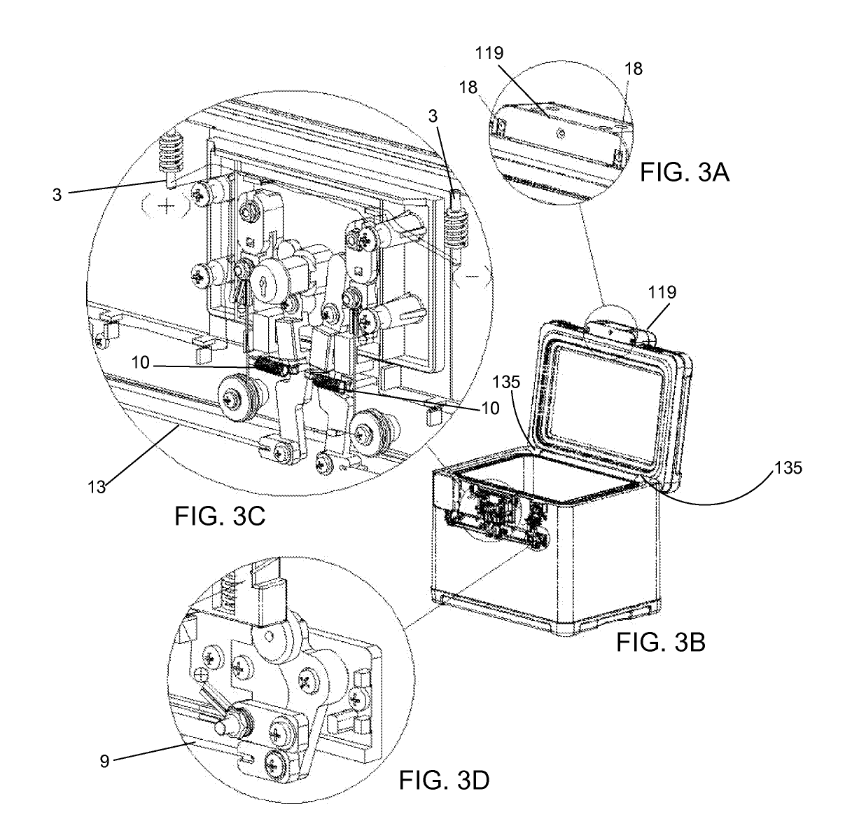

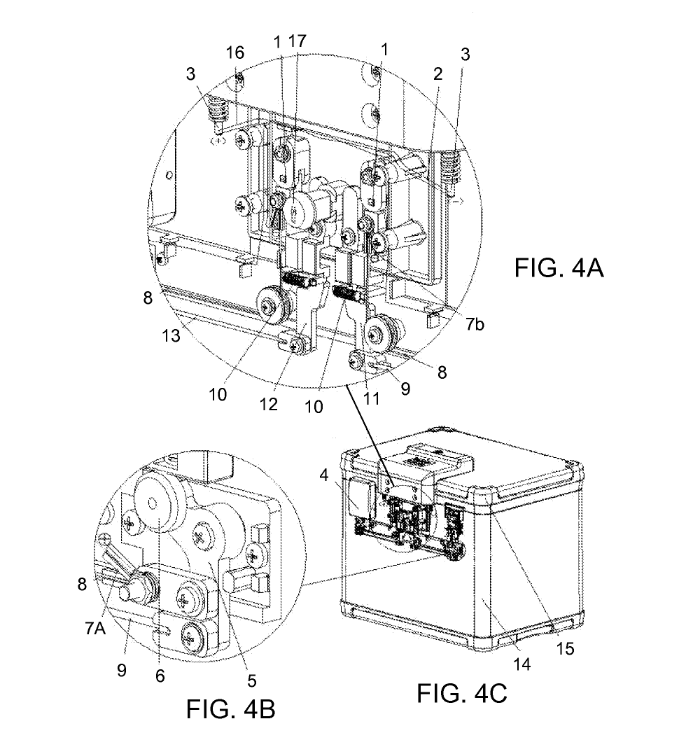

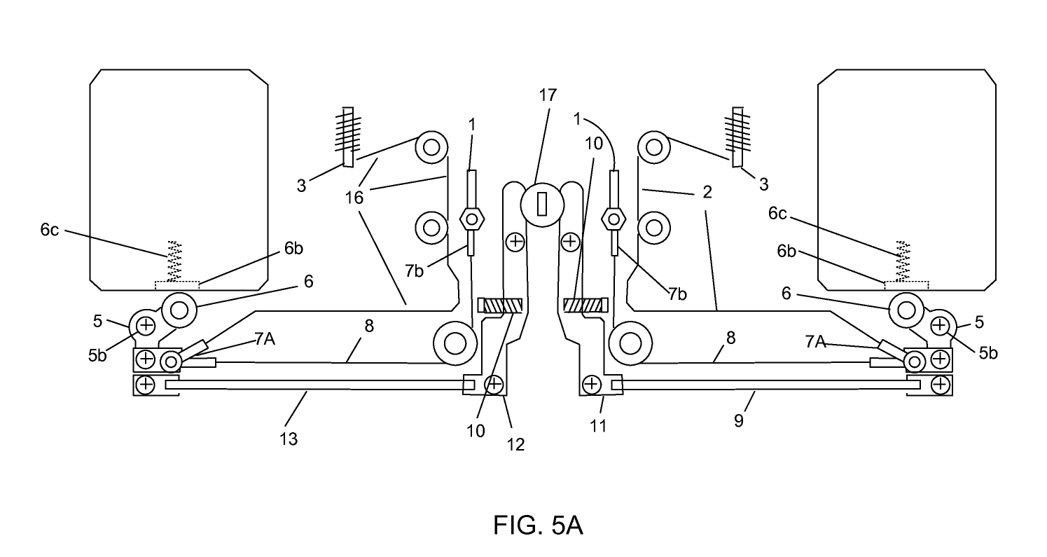

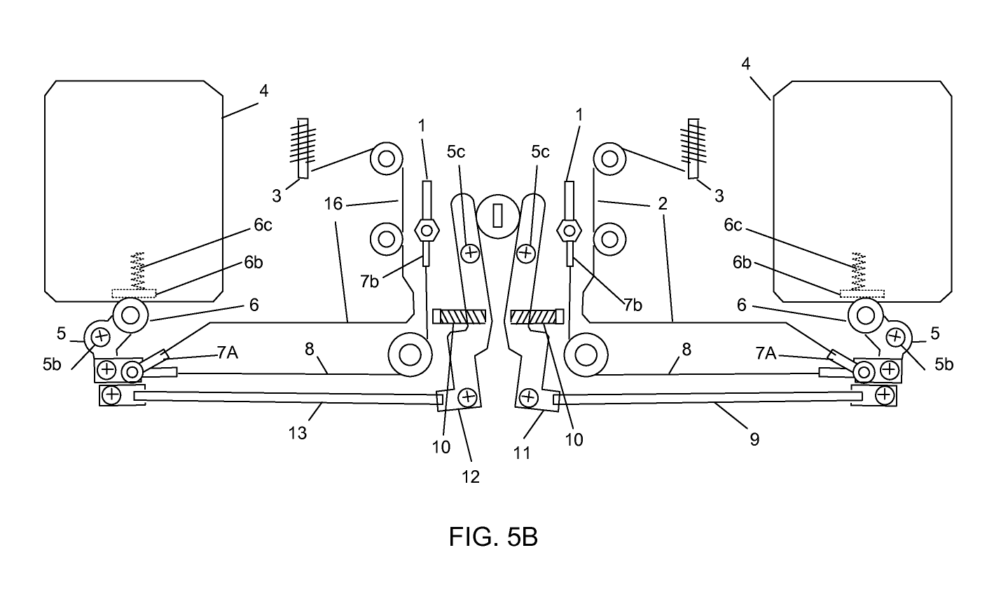

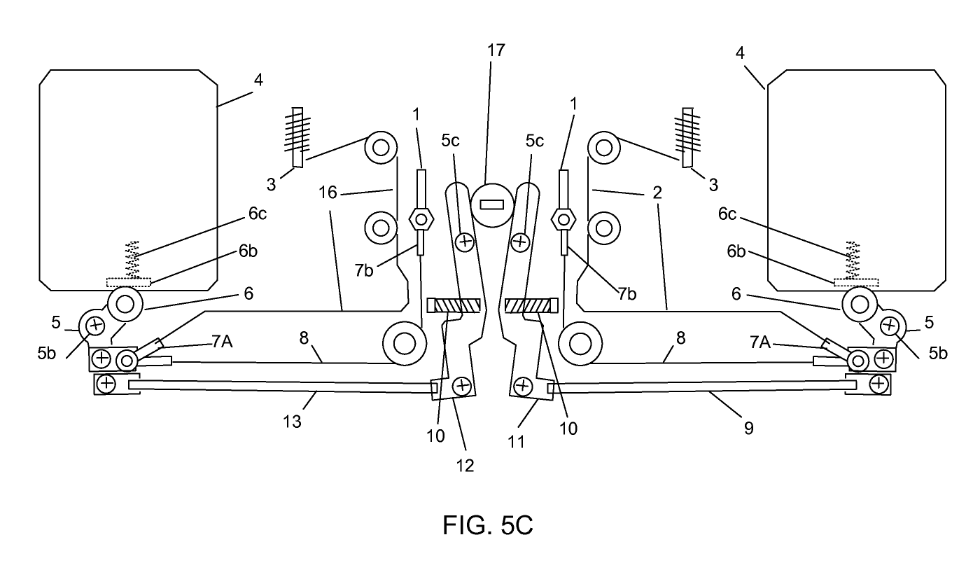

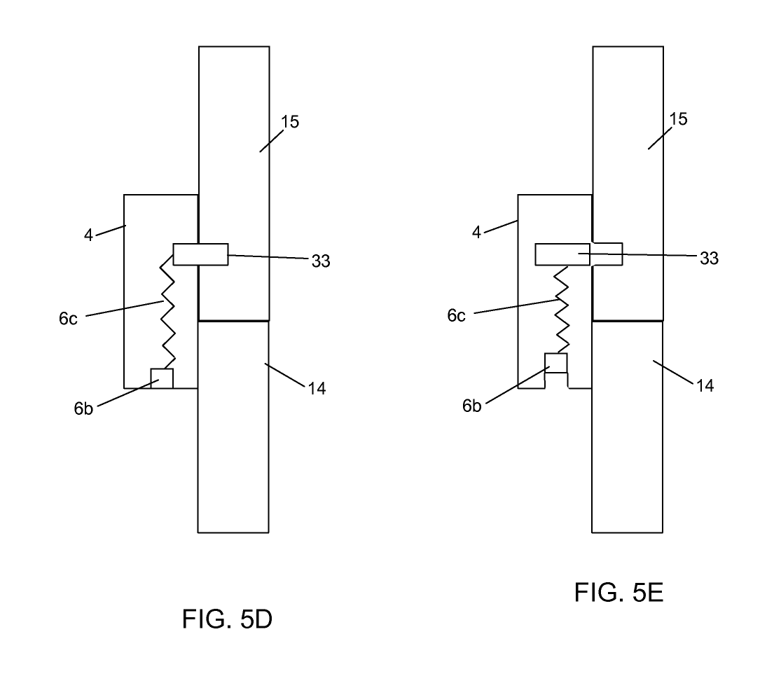

Key pad 113 allows safe 100 to be opened without the use of a key. When the correct passcode is entered via keypad 113 (see also FIGS. 2A, 2B), a 3V electrical signal is transmitted from keypad 113 through electrode plates 18 to electrode rods 3 (FIGS. 2B, 3A). Electrode plates 18 extend downward through front cover 119 (FIG. 3A). The electrical signal passes through electrode plates 18 to electrode rods 3, which then passes the electrical signal through the positive terminal wire 16 and negative terminal wire 2 to crimps 7A (FIG. 5A) that are attached to Nitinol wires 8 (see also FIGS. 4A-4B). When a current passes through Nitinol wire 8, the length shortens, pulling on rotatable push plates 5 and causing them to turn (FIG. 5B). Rotatable push plates 5 function as a latch assembly opening mechanism. As rotatable push plates 5 turn, wheels 6 move upwards, pushing onto the latch buttons 6b, which activates internal spring mechanism 6c. Locking tab 33 is then pulled clear of lid 15 thereby releasing latch assembly 4 from lid 15 (FIGS. 3A-5E).

When Nitinol wire 8 shortens, it pulls on the rotatable push plates 5. Simultaneously, push rods 9 and 13 push the bottom half of lock levers 11 and 12 to move against the center, causing a tension on lock lever springs 10 (FIGS. 5B and 3C).

The electrical signal is transmitted for approximately 3 seconds. After 3 seconds, Nitinol wire 8 lengthens and returns back to its original length. At this time, the lock lever springs 10 pull lock levers 11 and 12. Lock lever springs 10 function as a This action moves push rods 9 and 13 causing the rotatable push plates 5 to turn to their original positions while pulling wheel 6 back to its original position, as shown in FIG. 5A.

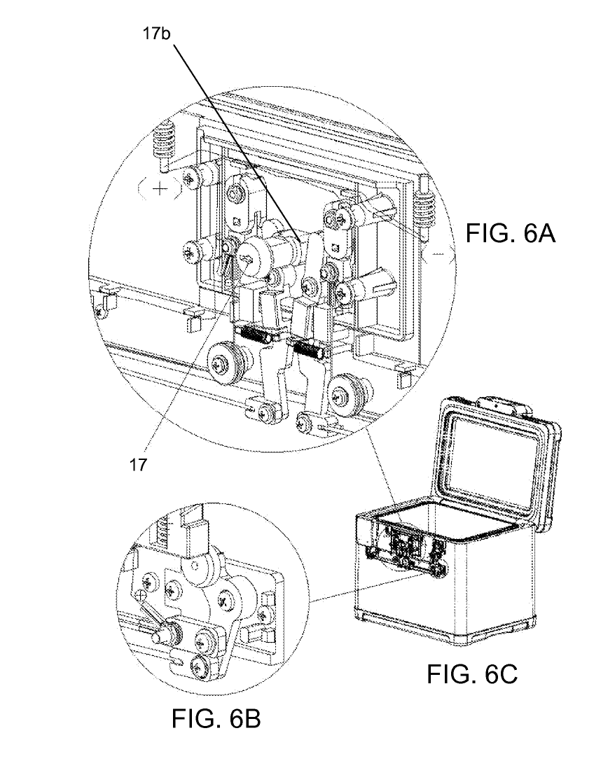

Using a key to turn key lock 17 (FIG. 5C), the top part of lock levers 11 and 12 is pushed apart by mechanism 17b (see also FIGS. 6A-6C). This action pulls push rods 9 and 13, which push wheels 6 to move upwards, pushing onto the latch buttons 6b, which activates internal spring mechanism 6c of latch assembly 4, releasing it latch assembly 4 from lid 15 (FIGS. 5A and 4C).

When environmental temperature reaches 75° C., low melt metal rod 1 (FIGS. 4A, 5A, 5B) melts and Nitinol wire 8 loses an anchor point, causing it to have no pulling force to push the wheels 6 to push onto latch buttons 6b to release the latch assembly 4. After low melt metal rod 1 has melted, key pad 113 can no longer be used to open the safe.

### Other Embodiments

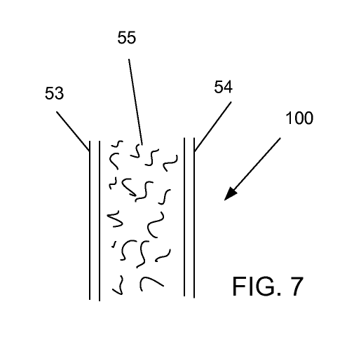

FIG. 7 shows that safe 100 can be a fireproof safe. For example box 4 includes interior wall 54 and exterior wall 53 with fireproof insulation 55 between. To make safe 100 a fireproof safe, all walls of box 14 and lid 15 include insulation 53 sandwiched between interior and exterior walls. Also, it should be noted that safe 100 can be fabricated from either plastic or metal.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A safe comprising:
A. a box,
B. a lid connected to said box via a hinge,
C. a latch assembly for locking said lid onto said box,
D. a latch assembly opening device connected to said latch assembly,
E. an electronic circuit comprising at least one Nitinol wire connected to said latch assembly opening device,
F. a user controllable keypad connected to said electronic circuit for allowing a user to transmit an electronic signal to said at least one Nitinol wire,
wherein said at least one Nitinol wire shortens after receiving said electronic signal causing said latch assembly opening device to move from its original position and to open said latch assembly to release said lid from said box so that said safe can be opened.

2. The safe as in claim 1, further comprising a user controlled key lock connected to said latch assembly opening device for controlling said latch assembly to release said lid from said box so that said safe can be opened.

3. The safe as in claim 1, further comprising at least one spring to return said latch assembly opening device to its original position.

4. The safe as in claim 3, wherein said at least one spring is two lock lever springs.

5. The safe as in claim 1, further comprising a low melt metal rod connected to said at least one Nitinol wire so that said Nitinol wire will lose its anchor after said low melt metal rod has melted.

6. A safe comprising:
A. a box,
B. a lid connected to said box via a hinge,
C. a latch assembly for locking said lid onto said box,
D. an electronic circuit comprising at least one Nitinol wire, said electronic circuit comprising:
i. a user controllable keypad,
ii. an electrode plate connected to said keypad
iii. a electrode rod removably connected to said electrode plate,
iv. an electrical connection wire connected to said electrode rod,
v. a Nitinol wire connected to said electrical connection wire,
E. a latch assembly opening device connected to said latch assembly, said latch assembly opening device comprising:
i. a rotable push plate connected to said Nitinol wire,
ii. a push rod connected to said rotable push plate,
iii. a lock lever connected to said push rod,
iv. a lock lever spring anchored to said safe and connected to said lock lever,
wherein said at least one Nitonal wire shortens after receiving said electronic signal causing said latch assembly opening device to move from its original position and to open said latch assembly to release said lid from said box so that said safe can be opened.

7. The safe as in claim 6, further comprising a user controlled key lock connected to said latch assembly opening device for controlling said latch assembly to release said lid from said box so that said safe can be opened, wherein said user controllable key lock is connected to said lock lever.

8. The safe as in claim 6 wherein said lock lever spring returns said latch assembly opening device to its original position.

9. The safe as in claim 8, wherein said lock lever spring is two lock lever springs.

10. The safe as in claim 6, further comprising a low melt metal rod connected to said at least one Nitinol wire so that said Nitinol wire will lose its anchor after said low melt metal rod has melted.

11. The safe as in claim 1, wherein said safe is a fire safe.

12. The safe as in claim 6, wherein said safe is a fire safe.

13. The safe as in claim 6, wherein said safe is fabricated from plastic.

14. The safe as in claim 6, wherein said safe is fabricated from metal.
